(19) United States
(12) Patent Application Publication
(10) Pub. No.: US 2020/0274753 A1
(43) Pub. Date: Aug. 27, 2020

(54) METHOD FOR CREATING AND MANAGING PERMISSIONS FOR ACCESSING YANG DATA IN YANG-BASED DATASTORES

(71) Applicant: HUAWEI TECHNOLOGIES CO., LTD., Shenzhen (CN)

(72) Inventors: Aihua GUO, Herndon, VA (US); Yinfeng Henry YU, Ottawa (CA)

(21) Appl. No.: 16/285,818

(22) Filed: Feb. 26, 2019

(51) Int. Cl. H04L 12/24

(52) U.S. Cl. CPC H04L 41/0213; H04L 41/145; H04L 41/0803

(57) ABSTRACT

The present disclosure provides methods and systems for creating and managing the accessibility of YANG-related data in YANG Datastore. Received requests for data access to YANG-related data from an application typically includes an owner ID and group ID information of the application. The owner ID is unique and the application ID of its owner application defined by a YANG module. The group ID is created and assigned to a group of applications by the owner application. The owner ID, group ID, and access rights information may be compared with an access modifier table defined by a YANG Datastore Manager. Based on the comparison, the application is allowed to execute the requested data access to the YANG-related data or is provided with an error message indicating the data access is denied.

### CROSS-REFERENCE TO RELATED APPLICATIONS

This is the first application filed for the instantly disclosed technology.

### FIELD OF THE INVENTION

The present disclosure relates generally to the field of software-defined networking (SDN), and in particular, to defining and controlling the accessibility of Yet Another Next Generation (YANG)-related data in a YANG Datastore.

### BACKGROUND

YANG is a data modeling language that provides data constructs and data element definitions to accommodate network modeling, and allows for the use of the data constructs in configuring network elements. YANG is often used in conjunction with Network Configuration Protocol (NETCONF) and/or RESTCONF (an Internet Engineering Task Force (IETF) draft defining the mapping of YANG specifications to a RESTful interface). Developments in SDN controller operations have extended YANG usage. The extended use of YANG has allowed it to become a more general purpose modeling language for model-driven network architectures.

Because the YANG model was originally designed for the NETCONF protocol, the data modeled by YANG are typically accessible by external entities in accordance with the NETCONF or RESTCONF protocols. In such cases, external entities may readily access and retrieve YANG model schema and may further retrieve or modify any data residing in a YANG Datastore. On the other hand, internal applications may also read/write any data in YANG Datastore. Therefore, the possibility exists that an application having access to YANG-related data may potentially retrieve or modify the data for other applications, which may result in data security issues.

Current YANG models do not possess data access control mechanisms to manage the retrieval or modification of YANG-related data. Moreover, the Network Configuration Access Control Model (NACM) of Request for Comments (RFC) 8341, does not address application or data access rules. Similarly, the OpenDaylight (ODL) model, as a SDN controller employing the YANG model, does not differentiate between internal models and external models, nor does it provide data access rules.

### SUMMARY

An object of the present disclosure is to provide methods and architectures of creating and managing permissions regarding access to YANG-based data stored and maintained within a YANG Datastore.

In accordance with this objective, an aspect of the present disclosure provides a method of managing the accessibility to YANG-related data in a YANG datastore, comprising: receiving a request for data access to the YANG-related data from an application, the request for data access including an owner ID and group ID information of the application, the owner ID being unique and being the application ID of its owner application defined by a YANG module, and the group ID being created and assigned to a group of applications by the owner application; comparing the owner ID and group ID information included in the data access request with an access modifier table defined by a YANG Datastore Manager; executing the requested data access to the YANG-related data when the comparison results in a match; and providing an error message to the requesting application when the comparison fails to result in a match.

In accordance with the embodiments of the present application, the access modifier table may be configured to define read and write permissions of the data entities defined by the YANG Datastore Manager. The read and write permissions may comprise one of the following indication values: private, application group and public.

Further, the method may comprise configuring the access modifier table in the YANG Datastore Manager. The method may further comprise configuring the access modifier table when registering the YANG module.

Generally stated, the present disclosure provides an architecture for managing the accessibility to YANG-related data stored in a YANG datastore, comprising: a server configured to receive a request for data access from an application, the request for data access including an owner ID and group ID information of the application, the owner ID being unique and being the application ID of its owner application defined by a YANG module, and the group ID being created and assigned to a group of applications by the owner application; a YANG Datastore Manager configured to manage the accessibility of the YANG Datastore; and an access policy controller module configured to compare the owner ID and group ID information included in the data access request with an access modifier table defined by the YANG Datastore Manager; wherein the server is configured to execute the requested data access to the YANG-related data when the comparison results in a match and to provide an error message to the requesting application when the comparison fails to result in a match.

In accordance with the embodiments of the present application, the access policy controller module may be configured to define read and write permissions of the data entities defined by the YANG Datastore Manager.

Implementations of the present disclosure each have at least one of the above-mentioned object and/or aspects, but do not necessarily have all of them. It should be understood that some aspects of the present disclosure that have resulted from attempting to attain the above-mentioned object may not satisfy this object and/or may satisfy other objects not specifically recited herein.

Additional and/or alternative features, aspects and advantages of implementations of the present disclosure will become apparent from the following description, the accompanying drawings and the appended claims.

### BRIEF DESCRIPTION OF THE FIGURES

The features and advantages of the present disclosure will become apparent from the following detailed description, taken in combination with the appended drawings, in which:

FIG. 1 illustrates a schematic diagram of a prior art method of data accessing in a SDN controller;

FIG. 2 illustrates a schematic diagram of one implementation of the method of providing a policy based access control for data access request, in accordance with the embodiments provided by the present disclosure.

FIG. 3A depicts a schematic diagram of an embodiment of the method of creating and adding new language construct in YANG grammar for access modifier in accordance with the embodiments provided by the present disclosure.

FIG. 3B depicts a registration API that allows an owner application to register a YANG module with an access policy controller module in accordance with the embodiments provided by the present disclosure.

FIG. 3C illustrates an API that allows a non-owner application to apply for joining a group to access a YANG module in accordance with the embodiments provided by the present disclosure.

FIG. 4 graphically illustrates a schematic diagram of a decision tree of data access request from an application in accordance with the embodiments provided by the present disclosure.

FIG. 5 depicts a schematic diagram of an access modifier table used to enforce data access policy in accordance with the embodiments provided by the present disclosure.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims.

### DETAILED DESCRIPTION

A detailed description of the present disclosure will be discussed with respect to the accompanying figures. The embodiments of the concepts disclosed herein are intended to be illustrative, as the scope of the present disclosure should not be limited to such.

Unless otherwise defined, all technical and scientific terms used herein have the same meaning as commonly understood by one of ordinary skill in the art to which the described embodiments appertain.

It is to be noted that the information conveyed above is specifically intended to provide a contextual reference that is believed to be of possible relevance to the ensuing disclosed embodiments. No admission is intended nor should it be construed that any of the preceding information constitutes prior art against the concepts and principles manifested by the embodiments described by the present disclosure.

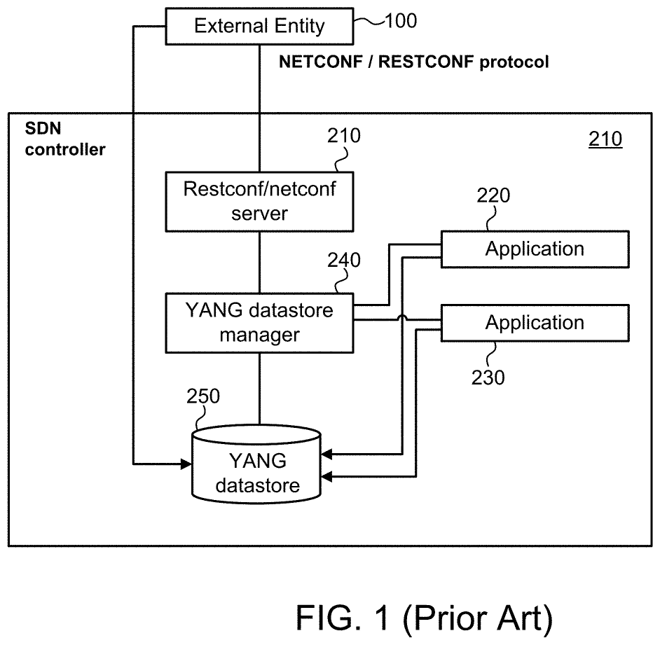

FIG. 1 (Prior Art) depicts an SDN controller (or a suitably configured network device) 200 that supports the YANG model scheme as well as the RESTCONF/NETCONF protocols. As shown, external entity 100 may gain access to data stored in the YANG Datastore via RESTCONF/NETCONF requests. In particular, external entity 100 may send a data access request to RESTCONF/NETCONF server 210. Upon receipt, RESTCONF/NETCONF server 210 forwards the data access request to YANG Datastore Manager 240, which manages the data used in the YANG model. YANG Datastore 250 may store all the data related to the operations of external entities 100 and internal applications 220, 230.

Meanwhile, internal applications 220, 230 may read and/or write any data in YANG Datastore 250. Although data in the YANG model may be defined as configurable, such as, for example, read/write or operational, all internal applications 220, 230 have equal data access rights. YANG Datastore Manager 240 is not configured with the capability of distinguishing between applications which try to access the data in YANG Datastore. As such, all YANG schema and related data are exposed to access from outside entities 100 or internal applications 220, 230.

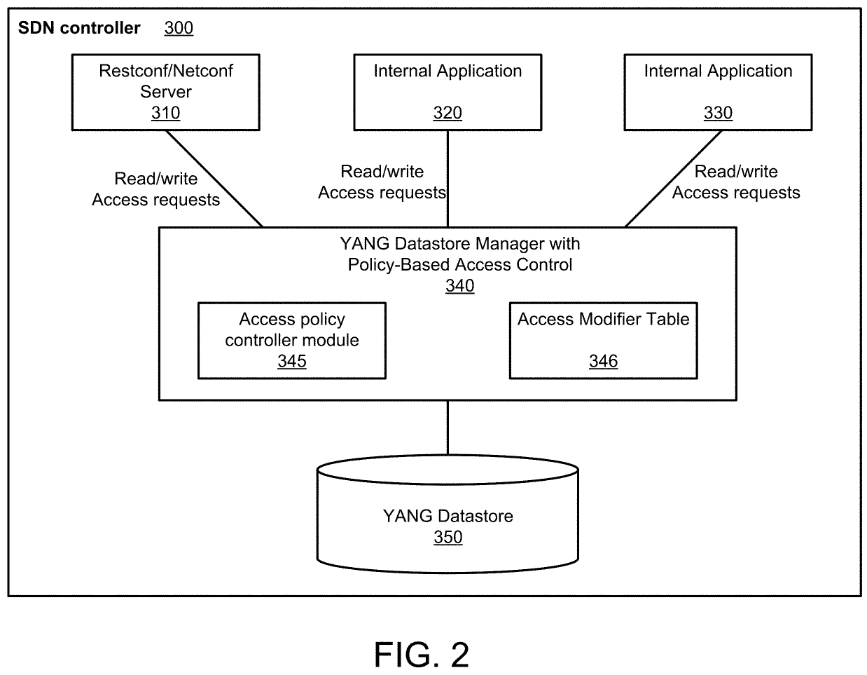

FIG. 2 illustrates a schematic diagram of one implementation of the method of providing a policy based access control for data access request, in accordance with the embodiments provided by the present disclosure. The policy-based access control may be implemented in a YANG Datastore Manager in accordance with YANG schema runtime management. As shown in FIG. 2, SDN controller 300, RESTCONF/NETCONF 310, and internal applications 320, 330 may send read/write access requests to YANG Datastore Manager in compliance with a policy-based access control 340 process to control and manage access of YANG-related data stored in a YANG datastore 350.

As shown in FIG. 2, the YANG Datastore Manager with policy-based access control 340 incorporates an access policy controller module 345 and an access modifier table 346, in accordance with the embodiments provided by the present disclosure. Each YANG module may be configured to have its own access modifiers (i.e., access rules). However, not each YANG module has its own access policy controller module 345. YANG datastore manager 340 has only one access policy controller module 345.

All the data access requests to the YANG datastore 350 may be approved or disapproved by access policy controller module 345. For example, access policy controller module 345 may define read and write permissions separately in accordance with a pre-specified indication value. The indication value of read or write permission may comprise one of the following 3 types:
Private—the data may only be accessed by an owner application. In the SDN controller, each YANG module may be registered to the YANG Datastore Manager by one application that is designated as the YANG module owner application.
Application Group (sometimes also referred to Group herein below)—only a group of applications, which are given a specific group ID, may have permission to access the data. The group ID may be created by the owner application and, in turn, the owner application may decide which applications should be assigned the group ID.
Public—no access restrictions are imposed to the YANG module data. The default value is Public, to accommodate backwards compatibility with the existing YANG implementations.

As noted above, the RESTCONF protocol has a feature that allows users to retrieve YANG-related data and modules (i.e., model schema-based) through the use of the SDN controller. However, by virtue of access policy controller module 345, only the Public YANG modules may be retrieved. This prevents the internal YANG modules (for example, Group and Private modules) from being exposed to access requests by outside entities.

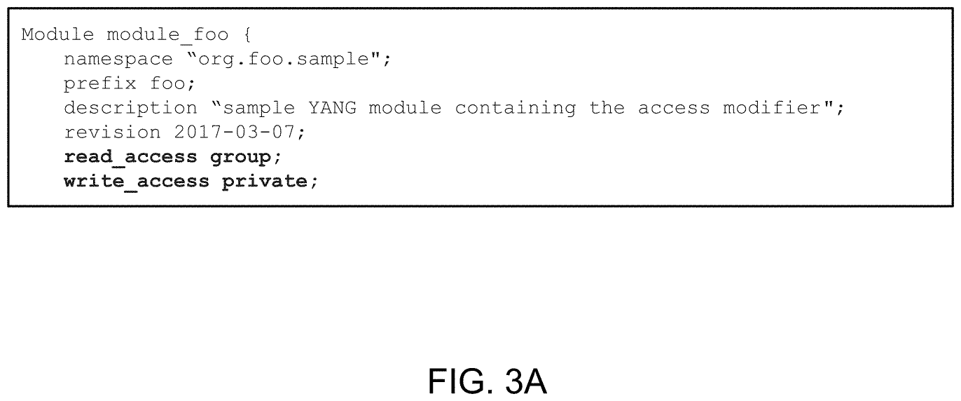

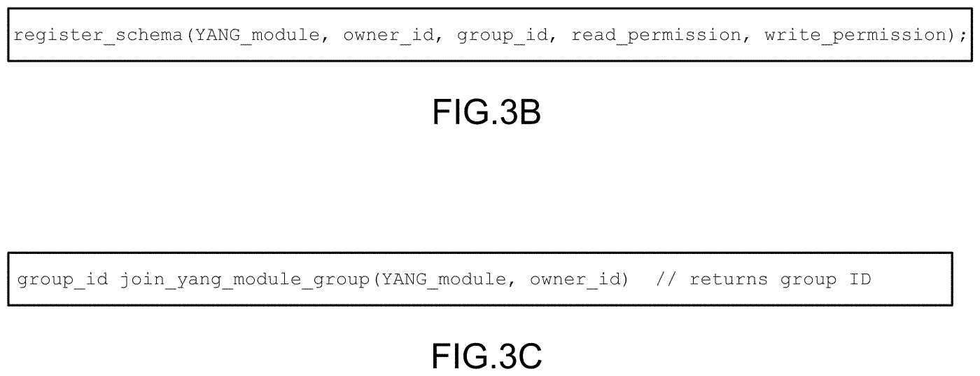

In this effort, and in accordance with embodiments of the present disclosure, a YANG language construct may be implemented to the “module-stmt” in the YANG grammar definitions for access policy controller module 345. The key word definitions are “read_access” and “write_access” for the field name, and Public, Group, and Private for the indication value. An example of the new YANG syntax construct defined according to this application is shown in FIG. 3A, where read_access may be assigned as Group and “write_access” as Private.

Once access policy controller module 345 is setup, all the settings are permanently written into a YANG module file, so that the modification of values are prevented during the lifetime of the application. The access policy controller module 345 enforces data access policies according to rules defined by the YANG modules' access modifiers.

In an alternative embodiment of implementing the access modifier is described herein. This alternative embodiment may be implemented during the runtime execution of YANG module. Specifically, a YANG module registration mechanism may be incorporated that allows the owner application to register the YANG module with the access policy controller module, as well as their owner IDs and group IDs. The YANG Datastore Manager may be configured to provide a registration API as illustrated in FIG. 3B and then enforce the access policy based on the related settings.

When the access policy controller module receives the owner application's registration request, if the requested YANG module is already defined the access modifier, then the access policy controller module will ignore the read_permission and write_permission parameters (i.e., the YANG module settings and parameters have a higher precedence and priority).

It will appreciated that the precedence may be overwritten by a flag, such as a debug flag. That is, if a flag is set, then the access policy controller module may use the settings of read_permission and write_permission, rather than that of the YANG module's.

If the registered YANG module does not contain access modifiers, then access policy controller module may use the read_permission and write_permission parameters. The default values are Public and Public respectively. Therefore, if the owner application does not set any values in read_permission and/or write_permission, the default values may be used.

As shown in the above, YANG_module indicates the name of a YANG module. Owner_id is the identification (ID) of the attribute of the owner module. The value may be NULL if the YANG module is not Private. Group_id shows the ID of the attribute of the group module. It may be NULL if the YANG module is not Application Group. Read_permission and write_permission may be Private, Application Group or Public. It is noted that the embodiment may be implemented independently. That is to say, this embodiment may be implemented without a YANG language extension.

As for owner ID, the present disclosure assumes that all applications that need to access YANG-related data have unique application IDs assigned by the SDN system. Every YANG module has one owner ID. The owner ID of the YANG module is its owner application's application ID. Every YANG module has only one owner application.

The YANG Datastore Manager manages the YANG schema registry to which all the YANG modules must register. A YANG module's owner application is responsible for registration, simply by calling the API as described above. It is noted that the owner application, as opposed to the YANG Datastore Manager, sets read and write permissions of the YANG module.

Likewise, as for group ID, a YANG module may have a group ID if it permits group access. And the group ID may be set by the owner application during the YANG module registration. Each YANG module may have at most one group ID. If a non-owner application wishes to access the YANG module that has group permission, it may first call an API to apply for joining the group, as shown in FIG. 3C.

The owner application may decide whether to grant the group permission or not. If the permission is granted, the API returns the group ID. Then, the application may access the YANG-related data with this group ID. Otherwise, an invalid ID is returned, which means that the application may not access the YANG-related data.

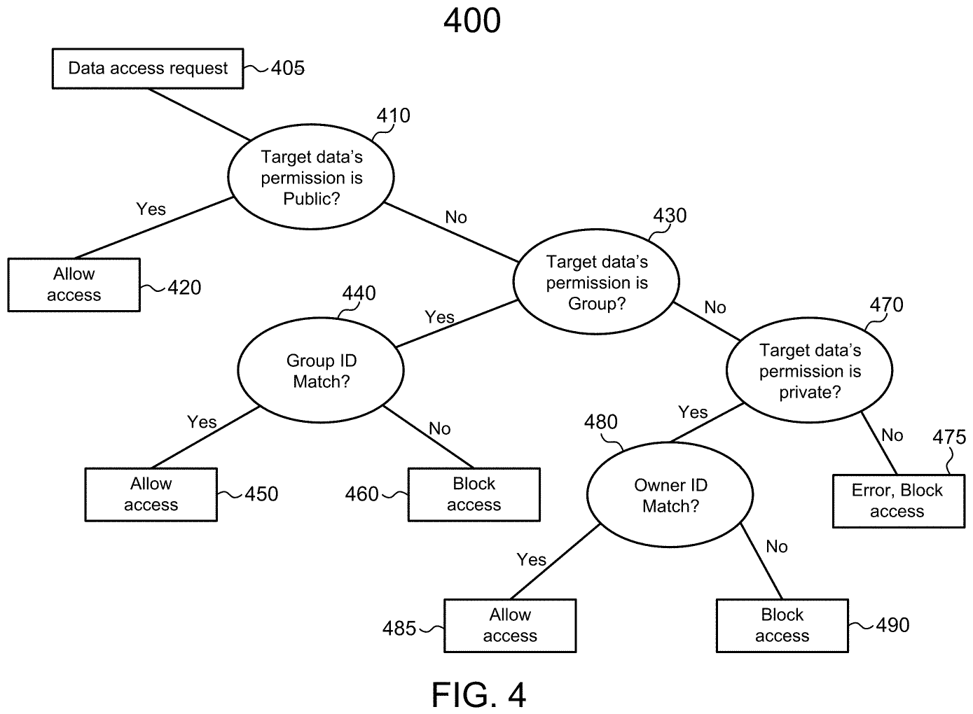

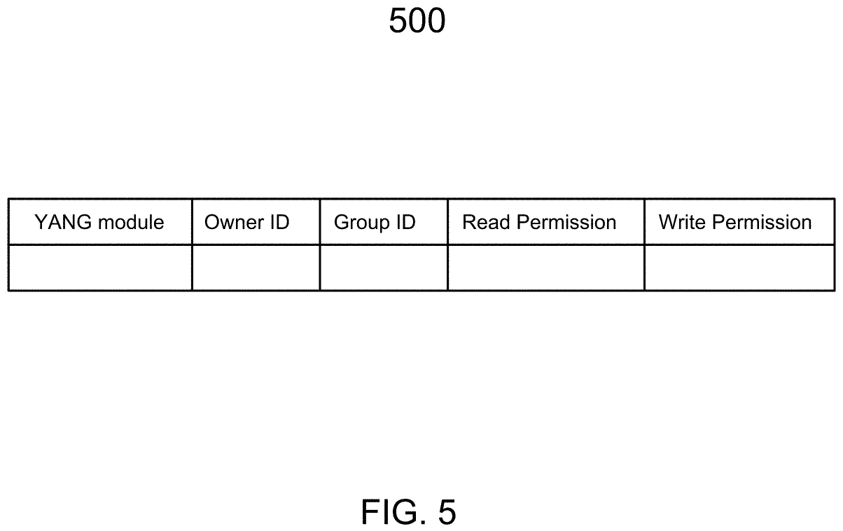

FIG. 4 illustrates a schematic diagram of processing decision tree 400 configured to accommodate data access requests from an application in a YANG model, in accordance with the embodiments provided by the present disclosure. In conjunction with processing decision tree 400, FIG. 5 illustrates a schematic format of access modifier table 500 that is constructed when applications register with the YANG modules and is utilized by decision tree 400 to enforce data access policies, in accordance with the embodiments provided by the present disclosure.

As shown in FIG. 5, access modifier table 500 provides the identification of the specific YANG module, the application's owner ID and group ID, the read permission public/private access levels allowed for read data access requests, and the write permission public/private access levels allowed for write data access requests.

Armed with access modifier table 500, when Yang Datastore Manager receives data access request 405 from an application, processing decision tree 400 is configured to perform the requested operations based on the results determined by decision tree 400, in compliance with the information specified in access modifier table 500. That is, upon receiving data access request 405, the YANG Datastore Manager refers to access modifier table 500 to identify access levels while traversing through processing decision tree 400.

In particular, as shown in FIG. 4, upon receiving a data access request 405 from an application, decision tree process 400 operates to identify in step 410 whether the target data's permission is Public, as identified by table 500. If it is identified as Public, the application may be allowed to access the requested data in the YANG Datastore, as noted by step 420. If the target data's permission is not identified as being Public, in step 430, decision tree process 400 operates to determine whether the target data's permission is directed to an Application Group, as identified by table 500. If so, in step 440, the YANG Datastore Manager may further decide whether the Group ID of the application matches Group ID in table 500. If the Group ID match, the requesting application may be allowed to access the data in the YANG Datastore, as noted by step 450. If the Group IDs do not match, the YANG Datastore Manager operates to block access to the data in the YANG Datastore, as noted by step 460.

Moreover, if the confirmation of target data permission in step 430 is negative, the YANG Datastore Manager may determine that the target data's permission is classified to be Private, as noted by step 470. If it is determined to be classified as Private, in step 480, the YANG Datastore Manager refers to table 500 to further determine whether the requesting owner ID matches the recorded Owner ID of table 500. If so, the application may be allowed to access the data in the YANG Datastore in step 485. Otherwise, in step 490, the YANG Datastore Manager may block the access to the data in YANG Datastore.

Furthermore, if the target data is not classified to be Private, as noted in step 470, an error may be returned from the YANG Datastore Manager and the requesting application may be blocked from accessing the data in the YANG Datastore in step 475.

In this manner, the disclosed embodiments provide protection and access control to data to YANG-based data resources and controls.

The present disclosure has been described in the foregoing specification by means of non-restrictive illustrative embodiments provided as examples. These illustrative embodiments may be modified at will. The scope of the claims should not be limited by the embodiments set forth in the examples, but should be given the broadest interpretation consistent with the description as a whole.

It will also be understood that, although the inventive concepts and principles presented herein have been described with reference to specific features, structures, and embodiments, it is clear that various modifications and combinations may be made without departing from the disclosures. The specification and drawings are, accordingly, to be regarded simply as an illustration of the inventive concepts and principles as defined by the appended claims, and are contemplated to cover any and all modifications, variations, combinations or equivalents that fall within the scope of the present disclosure.

What is claimed is:

1. A method of managing the accessibility to YANG-related data in a YANG datastore, comprising:
receiving a request for data access to the YANG-related data from an application, the request for data access including an owner ID and group ID information of the application, the owner ID being unique and being the application ID of its owner application defined by a YANG module, and the group ID being created and assigned to a group of applications by the owner application;
comparing the owner ID and group ID information included in the data access request with an access modifier table defined by a YANG Datastore Manager;
executing the requested data access to the YANG-related data when the comparison results in a match; and
providing an error message to the requesting application when the comparison fails to result in a match.

2. The method of claim 1, wherein the access modifier table is configured to define read and write permissions of the data entities defined by the YANG Datastore Manager.

3. The method of claim 2, wherein the read and write permissions comprise one of the following indication values: private, application group and public.

4. The method of claim 1, further comprising configuring the access modifier table in the YANG Datastore Manager.

5. The method of claim 1, further comprising configuring the access modifier table when registering the YANG module.

6. A system for managing the accessibility to YANG-related data stored in a YANG datastore, comprising:
a server configured to receive a request for data access from an application, the request for data access including an owner ID and group ID information of the application, the owner ID being unique and being the application ID of its owner application defined by a YANG module, and the group ID being created and assigned to a group of applications by the owner application;
a YANG Datastore Manager configured to manage the accessibility of the YANG Datastore; and
an access policy controller module configured to compare the owner ID and group ID information included in the data access request with an access modifier table defined by the YANG Datastore Manager;
wherein the server is configured to execute the requested data access to the YANG-related data when the comparison results in a match and to provide an error message to the requesting application when the comparison fails to result in a match.

7. The system of claim 6, wherein the access policy controller module is configured to define read and write permissions of the data entities defined by the YANG Datastore Manager.

8. The system of claim 7, wherein the read and write permissions comprise one of the following indication values: private, application group and public.

9. The system of claim 6, where the access modifier table is configured in the YANG Datastore Manager.

10. The system of claim 6, wherein the access modifier table is configured when the YANG module is registered by its owner application.
